(19) United States
(12) Patent Application Publication
(10) Pub. No.: US 2007/0008181 A1
(43) Pub. Date: Jan. 11, 2007

(54) System and method for optimizing the utilization of space

(75) Inventors: Andrew Rollert, Waltham, MA (US); James Andrews, Cambridge, MA (US)

Correspondence Address: FOLEY & LARDNER LLP, 321 NORTH CLARK STREET, SUITE 2800, CHICAGO, IL, 60610-4764, US

(73) Assignee: SpotScout, Inc.

(21) Appl. No.: 11/408,316

(22) Filed: Apr. 21, 2006

Related U.S. Application Data
(60) Provisional application No. 60/673,753, filed on Apr. 21, 2005.

(51) Int. Cl. G08G 1/14

(52) U.S. Cl. 340/932.2

(57) ABSTRACT

A system and method for providing a service allowing a user looking for an available space to access a secure network and specify parameters defining the user's requirements for the available space, while allowing other users to broadcast space information regarding spaces they are about to depart from, where space is a three-dimensional volume or position that can be occupied or vacated. Users communicate with the secure network which is comprised of dedicated and/or external data sources and servers, using electronic devices to retrieve and broadcast real-time and future space information so that users may conduct space exchanges either by paying and receiving set amounts for an available parking space or by bidding on an available parking space. Users can also rate the space exchange according to whether or not they were satisfied or dissatisfied with the transaction.

### FIELD OF THE INVENTION

The present invention relates generally to the field of space utilization. More specifically, the present invention relates to a communication network and associated method for exchanging space information between interested parties in order to optimize utilization of that space.

### BACKGROUND OF THE INVENTION

This section is intended to provide a background or context to the invention that is recited in the claims. The description herein may include concepts that can be pursued, but are not necessarily ones that have been previously conceived or pursued. Therefore, unless otherwise indicated herein, what is described in this section is not prior art to the description and claims in this application and is not admitted to be prior art by inclusion in this section.

“Space” is a three-dimensional volume or position that may be physically occupied by a single person and/or vehicle or a set of persons and/or vehicles, where the right to physical occupancy of the position is determined at least in part by occupying the position. Finding space entails determining, whether visually or audibly, if one party intends to vacate their occupied space. The world's population is constantly growing, resulting in a rapid diminishment of available space for the population to utilize. This has been a well known and increasingly difficult problem to solve in many areas, especially urban centers where that available space can encompass anything from a parking space to a seat in a cafe. Many can relate to the frustration of repeatedly driving around city blocks hoping find an available parking space or following a person in a mall parking lot, hoping to take their parking space. Another common occurrence is entering a crowded movie theater, only to discover that the only available seats are in the front row.

Continuing with the parking space example, attempts to alleviate overcrowding by erecting taller parking structures or building out into less crowded areas cannot keep up with the rate of growth. Moreover, these attempts to solve the problem can be extremely expensive, intrusive, and many times inconvenient, as people are forced to conduct their activities from further and further away. More recent solutions have attempted to solve the problem but still leave much to be desired. For example, certain parking garages now employ a system whereby each parking space is equipped with some type of sensor that will sense when a vehicle is occupying that space. This information is then relayed to a central system that will display the total free or occupied spaces that are available in the parking garage to incoming vehicles upon or just before entering the parking garage. Other systems strive to utilize wireless technologies to help guide a driver to an actual available space within the parking garage itself. Still other systems attempt to integrate these parking methods with electronic concierge and/or traffic monitoring systems so that available parking spaces can be provided at the closest location(s) to a desired endpoint, and predictions can be made regarding potentially available parking spaces.

Unfortunately, these systems and methods described above are very localized, being implemented in a single parking garage or a group of parking garages in a small geographic area, for example. Moreover, specialized equipment such as the above-mentioned sensors must be present at each and every parking space in order for availability information to be gathered and processed properly. This makes implementing such systems very expensive for the city or the garage owner, and provides limited convenience in that many disparate systems would need to be accessed by a driver traveling through multiple geographic areas. Furthermore, reserving an available parking space using these current systems and methods require reservations made well in advance thus failing to address the more dynamic/real-time needs of many of today's drivers. Finally, such systems and methods can only be applied to facilities that already engage in this type of service. Therefore, currently there are no possibilities for the owner of a private space owner to offer up his or her space for use, or for the possessor of a public parking space to broadcast detailed information relating to their exact time of departure and the specific location of the public parking space.

These space issues are not only applicable to parking, but as mentioned above, can arise in the area of movie theaters, marinas, queues, or any other events/locations utilizing unassigned seating or unmanaged, decentralized positioning of the public, such as bars, restaurants, and standing room only concerts, for example. Moreover, online auction sites for static/tangible goods and/or one-time services are ill-equipped to handle space demands as available spaces are not permanent things, but may become available over and over again. Thus the time it would take to connect to an online auction service provider and continually re-list an available space would be both cost and time prohibitive, because such services are designed to handle transactions involving more tangible objects.

### SUMMARY OF THE INVENTION

The present invention comprises a system and method for aggregating a plurality of relevant space information from external systems, broadcasting such information to interested users, and allowing transactions regarding space. This information can include, but is not limited to, location, availability, price, and spatial parameters. At the same time, users can utilize the same system to broadcast space information about their own available space over which they have at least partial control to generate their own revenue. Transactions between those broadcasting available space information and interested users can then be entered into and controlled. Such actions can include but are not limited to, account management, bidding, monetary transfers, exchange coordination, and directional assistance. A user interface layer can be used as a front-end to provide and receive information to and from the external systems and human users. The user interface layer in turn, can interact with a network application acting as a back-end, where the network application comprises a service layer, domain layer, and data layer. Finally, the aggregated space information itself is a product that can be utilized by or integrated into systems used by existing space vendors or those who need to control the allocation of space.

With the present invention, real-time, dynamic space information can be broadcast and received, allowing the utilization of available space to be optimized. Those who have available space and those who desire to use space can be brought together and allowed to quickly and safely interact. Moreover, any money exchanges are completed within the system negating the need for physical transfers of cash. This optimization further makes space utilization more efficient, and can effectively reduce various kinds of traffic in congested areas by allowing those who desire to use space to quickly find and occupy a space. Moreover, previously unrealized channels of revenue can be opened, creating a new marketplace environment, for example, by allowing a person to put a monetary value on information relating to an exact time of departure from a space.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a diagram of a basic electronic device with which various embodiments of the present invention may be used;

FIG. 2 is a diagram of a system view of the internal elements of a basic electronic device with which various embodiments of the present invention may be used;

FIG. 3(a) is a diagram of a system architecture within which various embodiments of the present invention may be implemented;

FIG. 3(b) is a diagram of the domain layer modules utilized in the network application of various embodiments of the present invention;

FIG. 3(c) is a diagram detailing the various types of human users that can possibly utilize various embodiments of the present invention;

FIG. 3(d) is a diagram of user and external system interaction with the network application of various embodiments of the present invention;

FIG. 4 is diagram of the basic front-end and back-end integration of network elements used in various embodiments of the present invention;

FIG. 5 is a diagram of the network protocols used by network elements in various embodiments of the present invention;

FIG. 6 is a diagram of the steps needed verify an account within various embodiments of the present invention;

FIG. 7 is a diagram of the steps needed find and select a location within various embodiments of the present invention;

FIG. 8(a) is a diagram of the steps needed to buy a space using various embodiments of the present invention;

FIG. 8(b) is a continuation of the diagram of the steps needed to buy a space using various embodiments of the present invention;

FIG. 9(a) is a diagram of the steps needed to sell a space using various embodiments of the present invention;

FIG. 9(b), is a diagram of the steps needed to verify a proper location prior to selling a space using various embodiments of the present invention;

FIG. 9(c) is a continuation of the diagram of the steps needed to sell a space using various embodiments of the present invention;

FIG. 10 is a diagram of the steps needed to confirm a space exchange using various embodiments of the present invention; and

FIG. 11 is a diagram of the steps needed to complete a monetary exchange using various embodiments of the present invention.

### DETAILED DESCRIPTION OF THE PREFERRED EMBODIMENTS

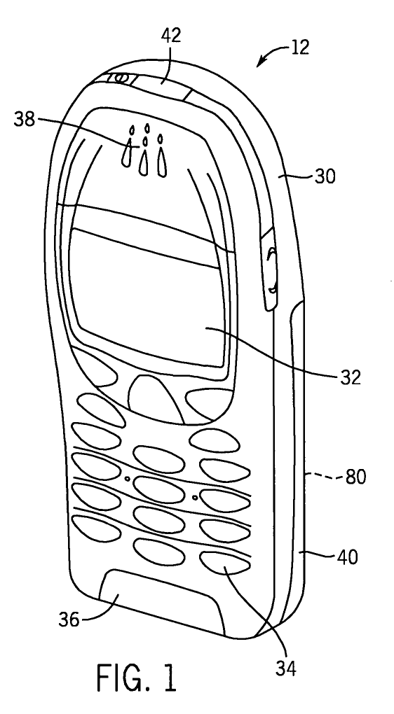

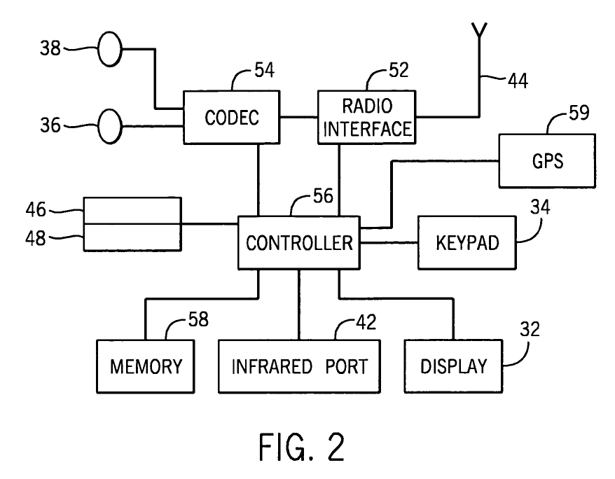

FIGS. 1 and 2 show one representative electronic device 12 within which the present invention may be implemented. It should be understood, however, that the present invention is not intended to be limited to one particular type of electronic device. The electronic device 12 of FIGS. 1 and 2 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 a memory 58, and a GPS module 59. Individual circuits and elements are all of a type well known in the art.

The electronic device may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio,satellite, WiFi, infrared, laser, cable connection, and the like.

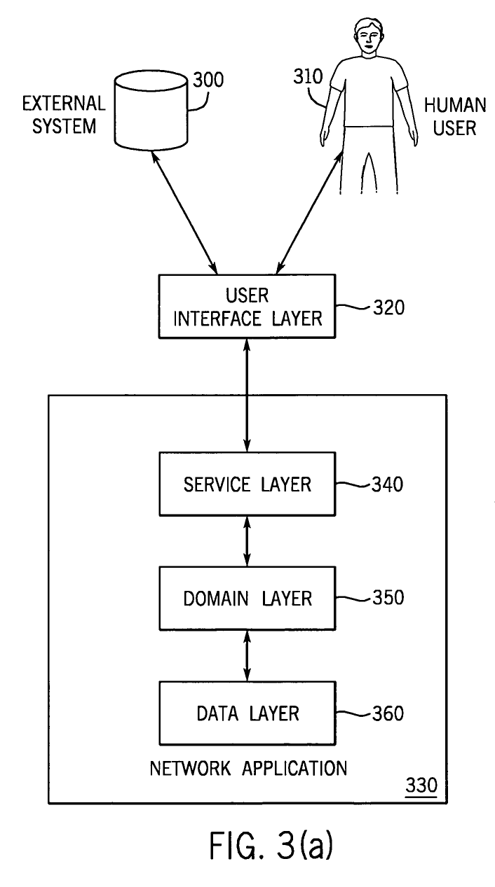

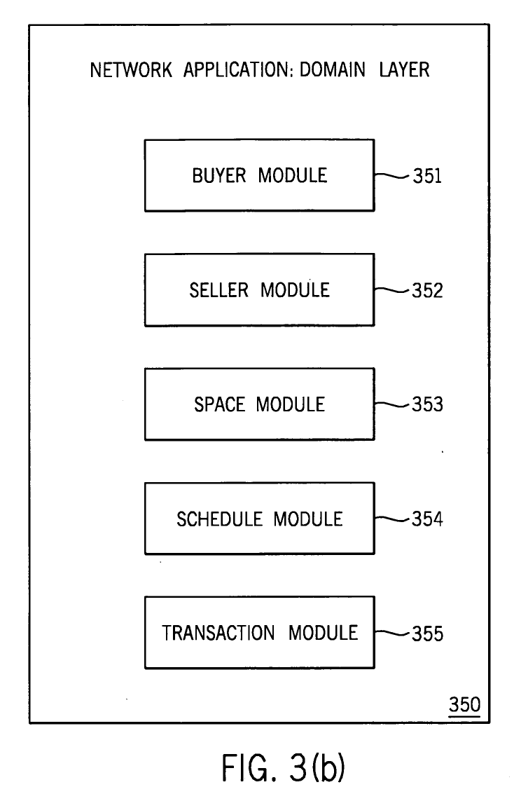

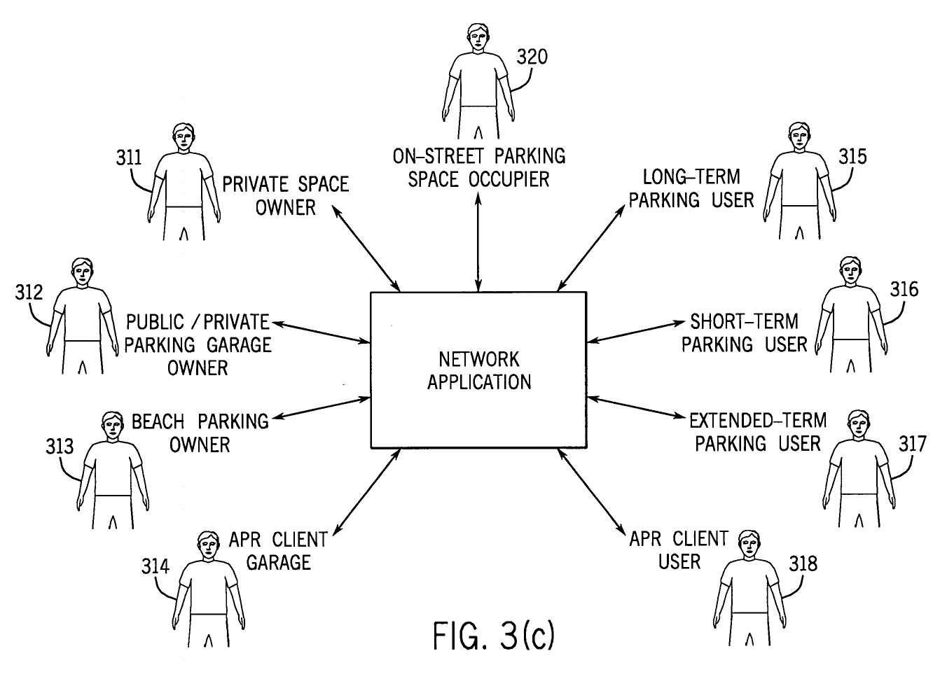

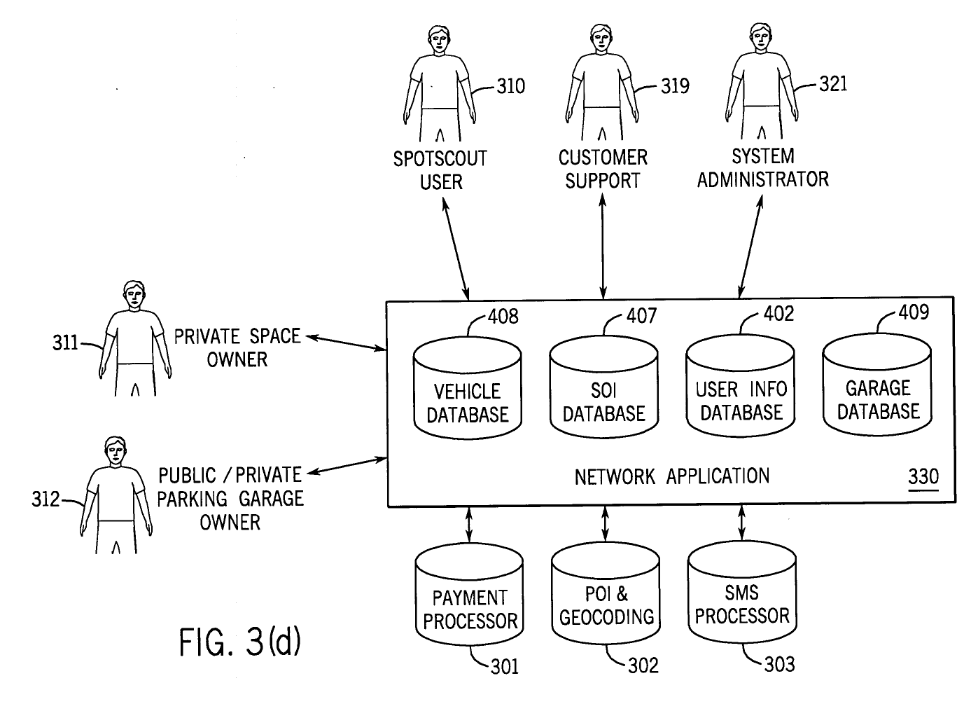

FIG. 3(a) shows a high level system architecture comprising the network elements of one embodiment needed to effect the space service provided by the present invention where external system 300 and a human user 310, both end-users, are shown to interact with a network application 330 of the present invention through a user interface layer 320. The user interface layer 320 can comprise one or more clients responsible for providing information to the end user and for receiving space, auction, and marketplace information from the end user. The exchanged information can include, but is not limited to, spatial information regarding an available space and/or a potential occupier of the available space, the location of a space, user account information, time and date of space availability, directions to an available space, related point of interest (POI) information, cost of a space, terms of a space exchange, and communications between end users. Possible interactions with the user interface layer 320 include, but are not limited to, client protocols such as phone-based voice extensible markup language (VXML), Java 2 Platform, Micro Edition (J2ME), extensible HyperText Markup Language (XHTML), Flash Lite, and browser clients that interact with personal computer (PC) and mobile device users, as well as visual and non-visual information delivery devices and automated service providers such as automated garages. An advantage to using the above client protocols is that access to the user interface layer 320 is carrier agnostic, meaning that an end user need not receive communications service from any specific service provider.

The network application 330 itself is comprises three layers: a service layer 340, a domain layer 350, and a data layer 360. The service layer 340 is responsible for receiving standard responses from a client and making the appropriate requests to the domain layer 350 to either set or get information from the underlying data layer 360, also referred to as a business logic layer. The domain layer 350 is comprised of a standardized set of getters and setters responsible for directly interacting with a data source or repository for either creating, retrieving, updating, or deleting information directly from the data source. The domain layer 350 can also aggregate information from multiple data sources. The data layer 360 is responsible for transaction and communication between the different modules of the domain layer 350 to be discussed below. The data layer 360 is also where all the data sources for the network application 330 reside.

Referring to FIG. 3(b), the organization of the domain layer 350 of the network application 330 is shown. The domain layer 350 is organized into modules which interact with each other through the service layer 340 to create the actual network application 330. These modules include first, a buyer module 351 which is responsible for storing and retrieving information directly related to a human user who is looking for information about available spaces within a given timeframe. This establishes who or what has access to the network in terms of retrieving information about space availability. Second, there is a seller module 352 which is responsible for storing and retrieving information directly related to a user who is interested in broadcasting information to the network regarding the availability of space at a specific time, time interval, or series of intervals. Third, there is a space module 353 that is responsible for storing and retrieving information directly related to the spaces that are broadcast to and available through the network at a specific time, time interval, or series of intervals, as well as the position of that space or area. Fourth, there is a schedule module 354 that is responsible for storing and retrieving information directly related to the times, either repeating or non-repeating, that a specific space becomes available, as well as, optionally, the duration in time of that availability. Finally, there is a transaction module 355 that is responsible for storing and retrieving information directly related to transactions that transpire due to the exchange of information between buyers and sellers within the context of the network.

Referring to FIG. 3(c), various possible types of human users such as private space owner 311, parking garage owner 312, beach parking owner 313, airport parking client garage 314, long-term parking user 315, short-term parking user 316, extended-term parking 317, airport parking client user 318, and on-street parking owner or possessor 320 are contemplated as being serviced by various embodiments of the present invention are shown. It should be noted that parking space operators as well as owners can also utilize the present invention. On the one hand, human users include any person or entity having a need for available space such as users needing long-term parking, short-term parking, extended-term parking, and other users that require long-term parking usually near an airport that utilize some form of online reservation system. At the other end of the spectrum are those users that can supply a parking space(s) such as private space owners, parking garage owners, beach parking owners, and airport reservation system garages.

Referring to FIG. 3(d), the interaction between the different types of users 310, the network application 330, and external system data sources and elements is shown. External data sources and elements are those elements that the network need not primarily control. In other words, the network can utilize third party service providers and vendors for tasks such as POI and geocoding support, SMS communications support, and payment processing. For example, instead of creating, populating, and maintaining a dedicated credit card debiting service to process monetary transactions arising from the use of the network, a third party's payment processing system may be accessed and utilized.

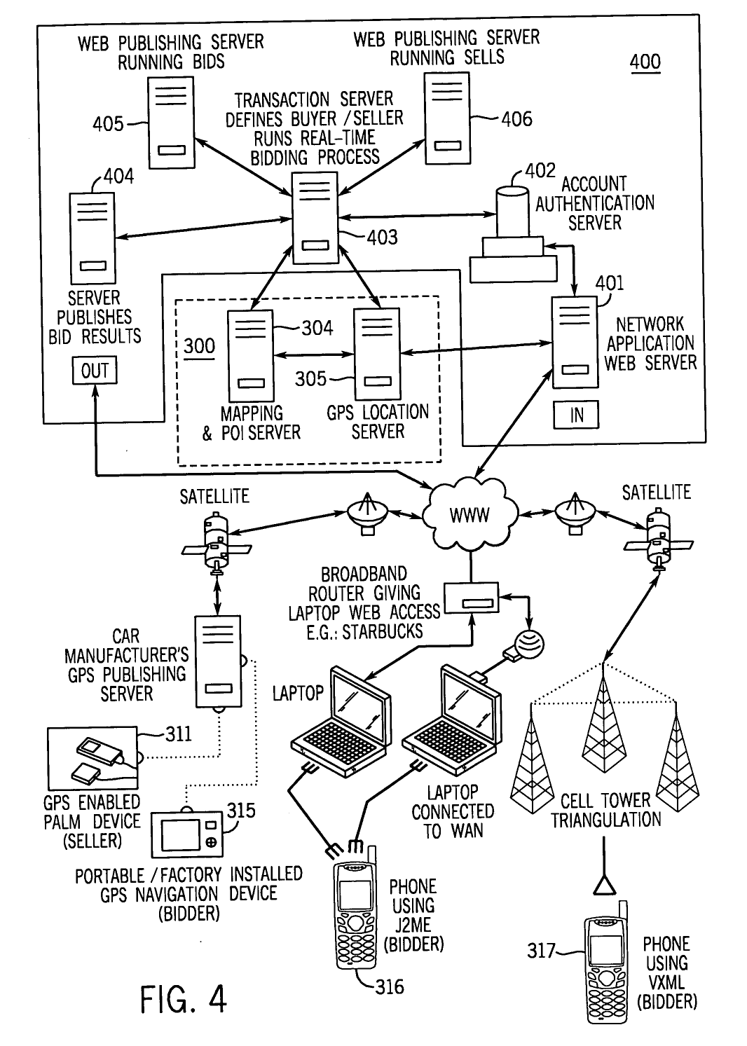

Referring to FIG. 4, an exemplary diagram highlighting basic front-end and back-end interaction in a network 400 within which the present invention is implemented is shown. The external system 300 is shown in more detail to comprise at least a mapping and POI server 301 and a Global Positioning System (GPS) location server. Other servers that can make up the 400 are a network application web server 401, an accounting database/server 402, a transaction server 403 for defining buyers and sellers, and for running a real-time bidding process, running bids, sells, and bid results, publishing servers 404-406. The seller using a GPS enabled PDA device 311, the bidder using a portable or factory installed GPS navigation device 315, the bidder using a J2ME-equipped telephone 316, and the bidder using a VXML-equipped telephone 317 are also shown in more detail as they interact with the network application web server 401 via satellite, WANs, and cellular communications networks. It should be noted that the various data sources can be implemented using a plurality of databases populated by tables or matrices resident in the network 400. Alternatively, the data sources may be external, pre-existing databases to which the system has access such as those in external system 300. Moreover, FIG. 4 is merely a representative showing of some of the possible systems, networks, and/or methods that comprise the present invention and allow connection thereto.

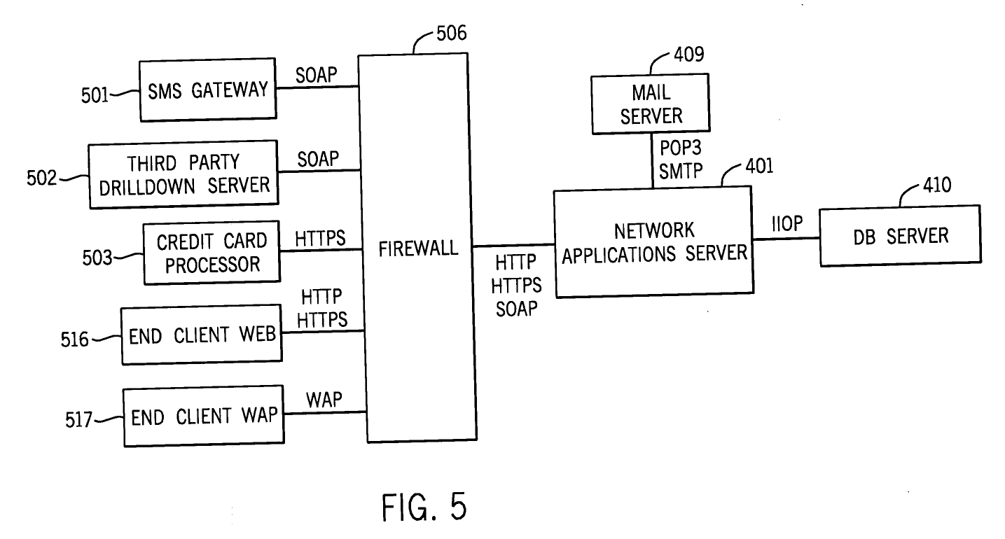

FIG. 5 is another diagram describing the network architecture of various embodiments of the present invention indicating the various data communication protocols that are used between the various network elements. The network application server 401 is shown along with examples of tools and/or applications running therein. A mail server 409 is shown to communicate with the network application server 401 using the common Post Office Protocol (POP3) and Simple Mail Transfer Protocol (SMTP). Furthermore, network application server 401 is also shown to communicate with an exemplary database server using Internet Inter-ORB Protocol (IIOP). It should be noted that although only one mail server and database server are shown, more than one of each server, as well as other servers providing necessary services may be utilized depending on the requirements of the network 400

FIG. 5 also shows firewall 506 that provides security for the network application server 401 and any other elements such as the mail server 409 and the database server 410 belonging to the network 400. On the other side of the firewall 506, the exemplary third party providers discussed above with their respective clients, servers, and gateways are shown to communicate with the firewall 506 using protocols such as, but not limited to, Simple Object Access Protocol (SOAP), Hypertext Transfer Protocol (HTTP), and Wireless Application Protocol (WAP), as well as HTTP scheme (HTTPS).

The network application 330 can be implemented on an Internet web server, such as the network application web server 401 operating within the network 400, or some other similar data/tele-communications network element. Thus, the network 400, comprised of its own data sources and/or external systems and data sources, acts as a back-end, aggregating space and space-related information and allowing and controlling transactions between end users and/or external systems regarding this space information. The network application 330 then acts as a front end application for the space service allowing for the easy and efficient accessing and interacting with the aggregated space and space-related information.

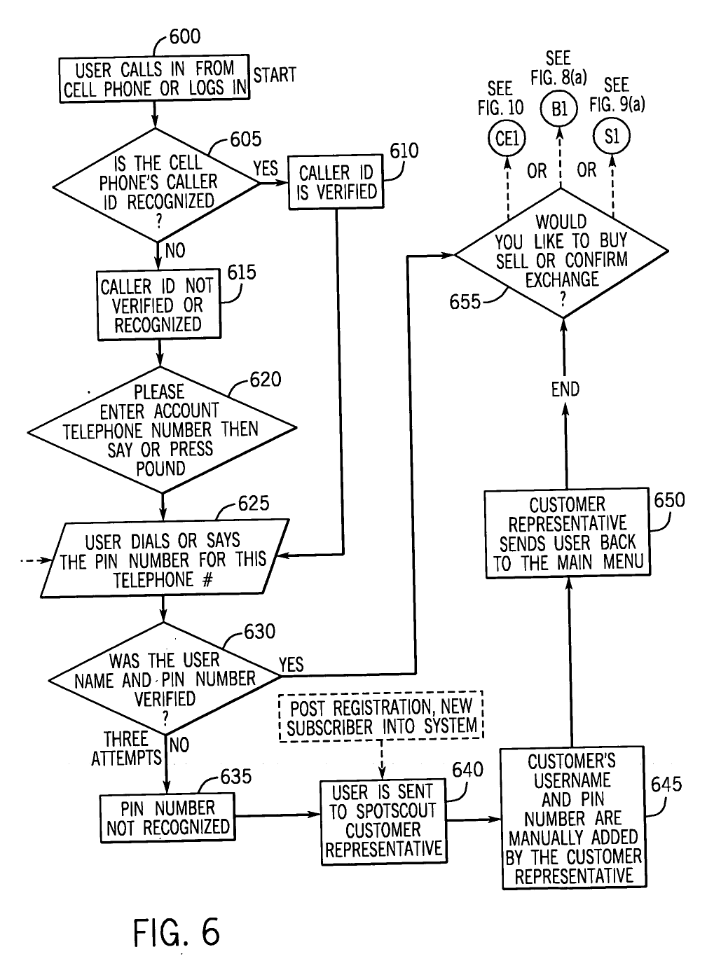

Accessing and utilizing the space service provided by the network application 330 can occur using a mobile interface or a browser-based PC interface. Access begins with an end user creating an account. The end user can either be a user wanting to broadcast his or her available space(s) or a user who is looking for an available space. Referring to FIG. 6, to access the network application 330, an end user may use any type of electronic device at step 600 that allows either manual or voice interaction with the network application 330. The type of electronic devices contemplated by the inventor can include, but are not limited to cellular telephones, personal data assistants (PDAs) with wireless communication capabilities, standalone GPS units, Blackberry™ devices, and in-car navigations systems. Referring back to FIG. 3(d), it is also possible to allow an end user to call into a call center and aurally exchange information with a call center agent or customer support representative 319 who can him or herself access the network application 330. For convenience, if an end user is using a web-enabled cellular telephone, interaction with the network application 330 can be put on hold while another communication, such as a voice call, is handled. Furthermore, the end user is returned the same point he or she left off in the interaction with the network application 330 after the other communication is completed.

At FIG. 6, it is determined whether or not the end user is authorized to access and use the network application 330. This is accomplished in one embodiment by checking the caller ID of the electronic device used by the end user, and if so, the end user is verified at step 610 and a password or PIN number is requested at step 625. If at step 615, the caller ID is not recognized, at step 620 the end user is requested to enter an account identifier such as a telephone number or other user ID. The end user then enters a password or PIN number at step 625. If the end user is verified at step 630, the end user is presented with menu options at step 655. If the end user has still not been verified, at step 635, the end user is connected to a customer service representative at step 640. The customer service representative will then manually enter the end user's account information or a new account can be created for the end user at step 645, and the end user will be presented with a menu of options at steps 650 and 655. Information regarding the end user to be inputted or collected can include the end user's name, address, email, telephone number(s), fax number, login name, password or personal identification number (PIN), and preferred method of notification. Also, payment information such as credit card information, location preferences such as were the end user normally parks his or her vehicle, and the end user vehicle(s) type, make, year, and model can be collected. This information is stored in accounting database/server 402 so that each subsequent time the end user logs into the network, the end user's account information will be retrieved and the end user can be authenticated and authorized to access the network.

A typical scenario involving the space service of the present invention is one where an end user is traveling to a destination in his or her vehicle and is searching for a parking space for that vehicle. This is referred to as SpotScouting. As will be discussed below, another typical scenario involving the present invention is one where an end user wishes to broadcast a parking space that he or she is about to leave. This is called SpotCasting. The SpotScouting end user uses an appropriate electronic device to access a login interface. For purposes of the present invention, the login interface can be a login screen for the network application 330, in which the end user inputs a user name and password or PIN either by pressing the appropriate information via a keypad of the cellular telephone or by speaking the appropriate information as already described above. Alternatively, access can be gained by dialing an access number and the login interface would be an interactive voice recognition (IVR) interface giving voice prompts to vocally enter the SpotScouting end user's login information. It should be noted that any of the following interfaces to be discussed below can be either a web-based or HTML-based interface or an IVR interface. Moreover, the inputting of information can be, as contemplated above, by VXML which essentially allows a VXML client to use voice to interact with a web interface just as if he or she were manually inputting information such as by typing, for example.

If the SpotScouting end user is successfully authenticated and authorized to access the space service as discussed above, a “confirm vehicle interface” is presented to allow the SpotScouting end user to select a choice associated with the vehicle he or she is driving or add a new vehicle. Because as discussed above, a SpotScouting end user's vehicle(s) information is collected, this information can be presented to the end user. If for example, the SpotScouting end user is driving the same vehicle whose information has been presented, he or she can confirm that they are in fact driving this vehicle. If not, the SpotScouting end user can enter the type, make, and model of the vehicle they are driving. Alternatively, the space service can present a listing of known and stored vehicle profiles for the SpotScouting end user to choose. As will be seen throughout the specification, any time the inputting of information or data is requested or required, the inputting can be accomplished either by entering or selecting the information via the pressing of keys or by voice.

Once the correct vehicle information is entered or selected, a “choose service interface” is presented to the SpotScouting end user. These services can include Find Parking, SpotCast, Confirmation Code, Rate Transaction, Location Preferences, Account Summary, and Confirm Arrival. The SpotScouting end user then chooses “location preferences.”

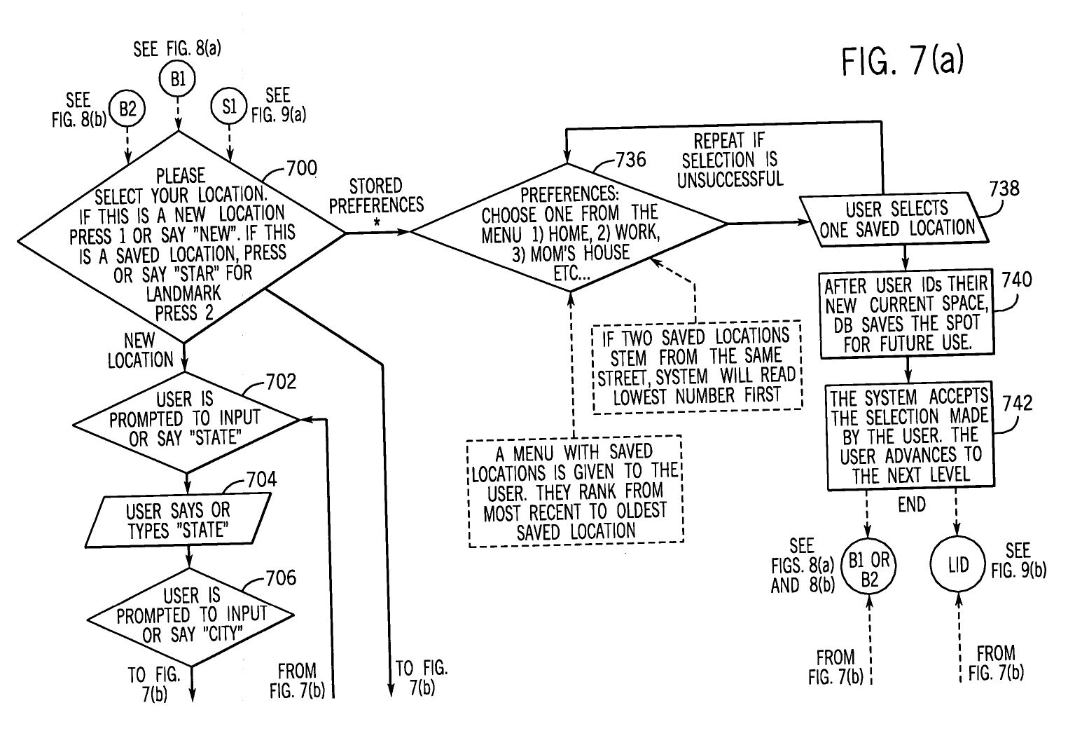

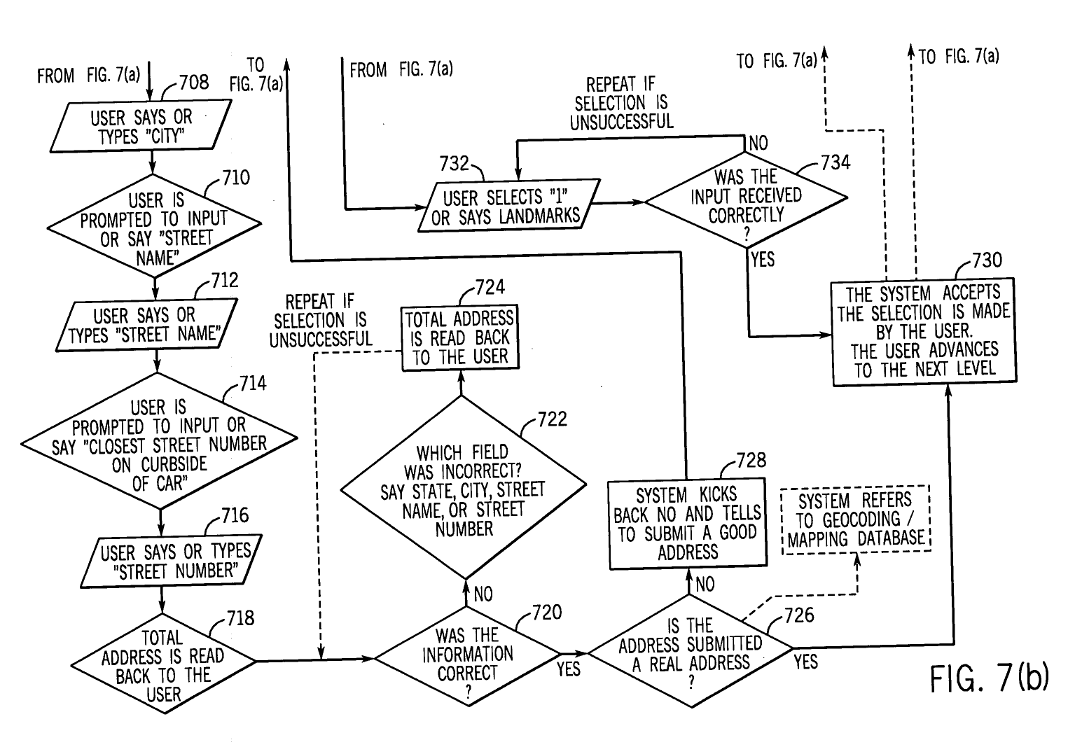

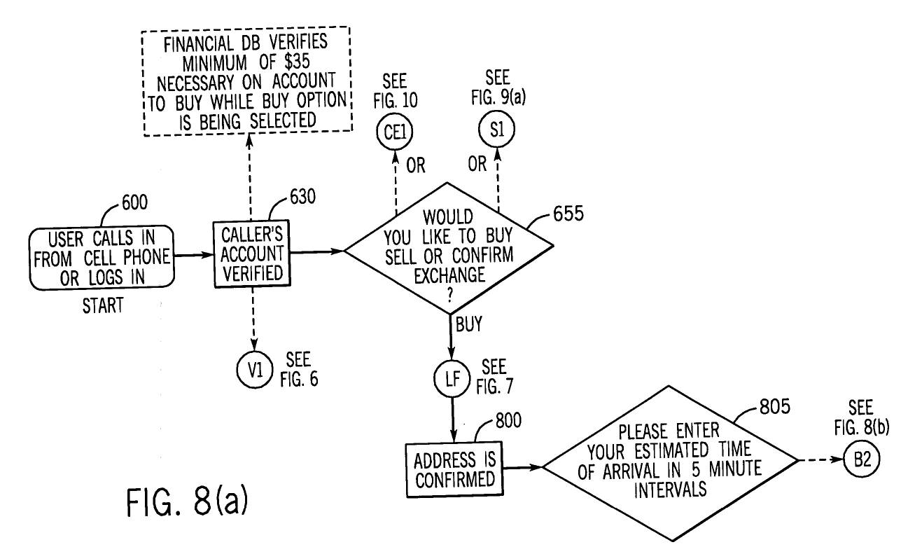

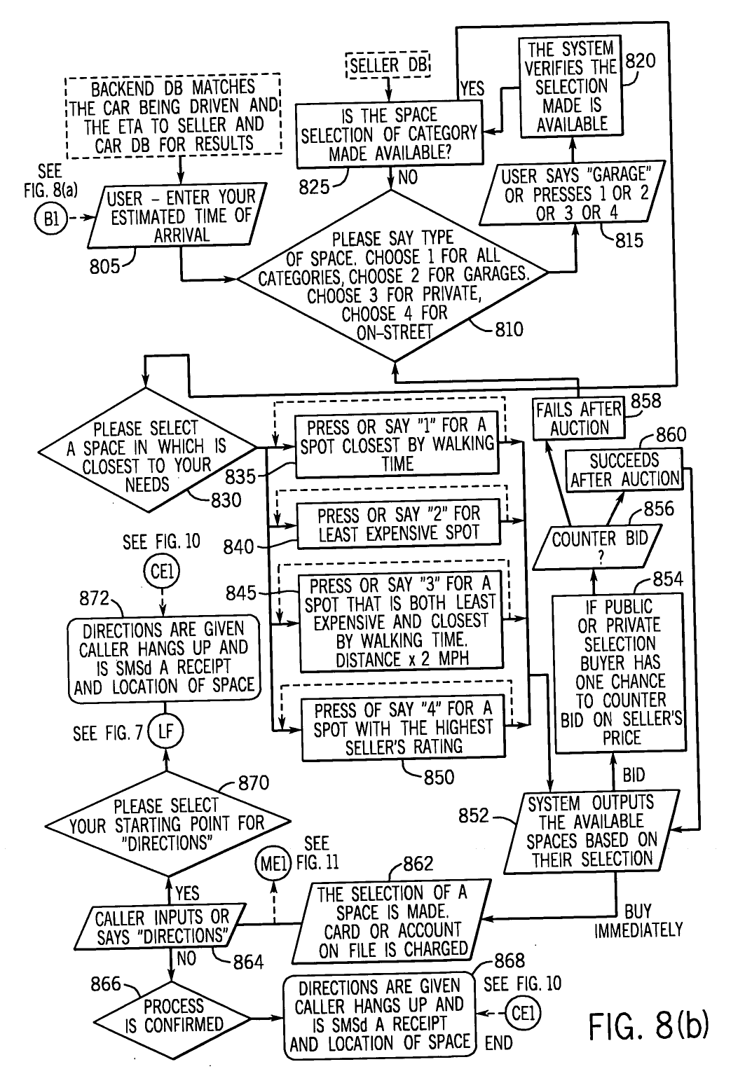

Referring to FIG. 7, a SpotScouting end user is presented with the option to select a previously entered and stored address associated with the SpotScouting end user's account, select a landmark, or enter a new desired location at step 700. The SpotScouting end user then is prompted to enter the state associated with the desired location at step 702 who then responds accordingly at step 704. The SpotScouting end user is then prompted to enter a city in step 706 who will respond with the desired city at step 708 At step 710, the SpotScouting end user is prompted for a street name to which the SpotScouting end user responds by entering the desired street name at step 712. Finally, the SpotScouting end user is prompted for the closet street number relevant to the desired location at step 714, and the SpotScouting end user can respond with the street number at step 716.

At step 718, the entered location information is presented back to the SpotScouting end user. The SpotScouting end user can then verify whether or not the desired location information relayed to him or her is correct at step 720. If the desired location information is incorrect, the SpotScouting end user is prompted to identify which portion of the desired location information is incorrect at steps 722 and 724. This is repeated until the SpotScouting end user is satisfied that the network application 320 has correctly interpreted the desired location information. At step 726, the desired location information is checked to determine whether or not it is actually a valid address. If the address is determined to be invalid, the SpotScouting end user is returned to step 702 where he or she can restart the process. If the address is valid, the address is accepted and the SpotScouting user is allowed to advance in step 730.

As mentioned above, step 700 allows the SpotScouting end user to select a nearby landmark to use as a reference location point as shown in step 732. Step 734 verifies whether or not the selection at step 732 was correct and the process is repeated until a valid landmark selection has been made. Alternatively, the SpotScouting end user can select a pre-determined, pre-recorded location as shown in step 736 and the selection is verified as well. Yet another alternative is to allow the SpotScouting end user to enter a “Spot of Interest” (SOI) number which is associated with a geocoded location, stored in an SOI database, and can be accessed by the network 400. An SOI number is an improvement on the POI concept, where businesses or service providers are registered as a “Spot of Interest” and assigned an SOI number. These SOI numbers will be available to SpotScouting end users who utilize the space service or if those businesses and service providers simply choose to advertise their SOI numbers to customers as they would their own telephone number or web address. In fact, the SOI number can simply be a telephone number. This is simply another way to specify an exact, desired location, and is advantageous to both the operators of the present invention and the businesses as it allows increased exposure to potential customers and results in SpotScouting end users knowing more about their surroundings. Individuals can even request personal SOI numbers to more easily route individuals to their exact address.

In yet another embodiment, the SpotScouting end user can perform a standard POI search to be discussed below. In this instance, a search by the POI interface is presented to the SpotScouting end user where the SpotScouting end user enters or chooses a predetermined general location area, such as a city and state or an area code. Further narrowing menu options are presented to the SpotScouting end user such as food, shops, bars, airports, hospitals, bathrooms, etc. The SpotScouting end user can then choose one of these categories and continue to drill down until he or she finds a specific place of interest. Once the place of interest is determined, the network 400 can access a POI database and retrieve location information associated with the point of interest and use that information as desired location near which an available parking space is desired.

It should be noted as well that any address entered by the SpotScouting end user can be saved for future reference as seen in steps 740 and 742. It should also be noted that to process the desired location preferences, any one or more of a number of data sources, internal or external to the network 400, can be accessed and utilized. This includes mapping and POI servers/databases 304 and GPS location servers/databases 305 for example.

FIG. 8(a) shows that after processing the desired location preferences and an address is confirmed at step 800, a select date/time slot interface is presented to the SpotScouting end user at step 805, where estimated time of use data can be entered. It is noted that estimated time of use can encompass an estimated date and time of arrival as well as an estimated period of desired use. The time can be and preferably is specified down to the minute. Referring to FIG. 8(b), all of the previously entered information to that point is used to define a query that accesses one or more of the above-discussed data sources or repositories and searches for available parking spaces meeting the criteria defined by the entered information. The available parking spaces can then be grouped according to, for example, Closest, Cheapest, By Rating, Garage Only, On-Street Only, Private Only, Commercial Resident, and Handicapped categories, one of which the SpotScouting end user chooses according to his or her needs in steps 810 and 815. The selection is verified in step 820 and it is determined if any available parking spaces fall under the SpoutScouting end user's selection at step 825.

A “search results interface” is presented to the SpotScouting end user at step 830 depending on which category is chosen that displays all the available parking spaces meeting that category criteria. If there is more than one parking space available, they may be presented in a certain order, for example, from cheapest to most expensive, or closest to farthest from the SpotScouting end user's destination. For example, at step 835, the SpotScouting end user can enter a “1” to choose an available parking space that is closest in walking distance to his or her destination. The SpotScouting end user can choose “2” to select and available parking space that is the least expensive as in step 840. Choosing option “3” presents the SpotScouting end user with an available parking space that is the least expensive and is closet by walking distance as seen in step 845. Finally, choosing option “4” in step 850 presents an available parking space that is based on its rating, which will be discussed in detail below. It is noted that a geocoding data source can be accessed to determine for example, the closeness of an available parking space so that estimated walking time from the parking space to the destination can be accounted for.

Once the SpotScouting end user has selected an appropriate available parking space as shown in step 862, the details of that parking space are presented to the end user and the SpotScouting end user's account is debited upon electronic acceptance of the terms of the transaction. This can include information such as hours of operation, rating, daily maximum rates, and behavior while occupying the (parking) space. The details can also include information regarding additional parking amenities available with that parking space, for example, a parking space within a garage that provides car wash, valet services, or vehicle escort.

One aspect of various embodiments of the present invention is the ability to allow SpotScouting end users to bid on available parking spaces. Bidding on an available garage parking space can also be accomplished. However, step 854 shows that a SpotScouting end user can bid on an available parking space if it is public or private. Counter-bidding is allowed at step 856. If a SpotScouting end user is successful at step 860, he or she is deemed to have selected the available parking space and allows his or her account to be debited in step 862. A losing SpotScouting end user at step 858 is simply allowed to reselect another available parking space Of course, counter-bid information is received, processed, and appropriately notified to those bidding SpotScouting end users. A time period for bidding can be predetermined or set by the SpotCasting end user, and the SpotScouting end user with the highest bid at the close of the bidding period wins the parking space and is provided with a confirmation number of the above transaction.

If the SpotScouting end user chooses to get directions to their chosen parking space, a “select starting point interface” is presented at step 864. Just as in setting the location preferences above, the SpotScouting end user can either enter a starting point address or select a previously entered and stored address associated with the SpotScouting end user's account as seen in step 870. Alternatively, the SpotScouting end user can enter an SOI number or perform a POI as described above. It is noted as well that any address entered by the SpotScouting end user here can be saved for future reference. Once the starting point information has been processed, driving directions will be presented to the SpotScouting end user either visually or via audio on or over the cellular telephone as seen in step 872. Preferably, turn-by-turn directions are given making it easy for the end user to follow. Alternatively, the driving directions can be delivered to the end user via short message service (SMS) and/or email, as specified during the registration procedure discussed above or after the starting point information has been processed. Otherwise, the SpotScouting end user merely confirms his or her selection and a receipt is sent to the SpotScouting end user via SMS, email, or other suitable notification method, where the receipt includes the exact location of the available parking space, a map, a confirmation numbers, and other details of the transaction. The reason the actual location of the available parking space is given only after the selection is confirmed is to prevent bidding SpotScouting end users to simply go to the available parking space and bypass the SpotScouting process.

As mentioned above, another space service provided by the present invention is one where an end user can broadcast a parking space that he or she is about to leave to SpotScouting end users. This is referred to as SpotCasting. To become a SpotCasting end user, one creates an account and login just as described above for a SpotScouting end user. Referring back to FIG. 7, once the SpotCasting end user has logged into the network application 330 and has chosen to SpotCast a parking space, he or she will be presented with a select location screen in step 700. Here, the SpotCasting end user can enter a new location where the parking space will become available or can choose to use a predetermined location such as his or her home or work address. If the SpotCasting end user chooses to enter a new location address, that new location address can be stored and tagged with some type of name or other identifier for future use. In entering a new location address, the end user may enter an SOI number or a complete address. Alternatively again, a POI search can be conducted to determine a desired location.

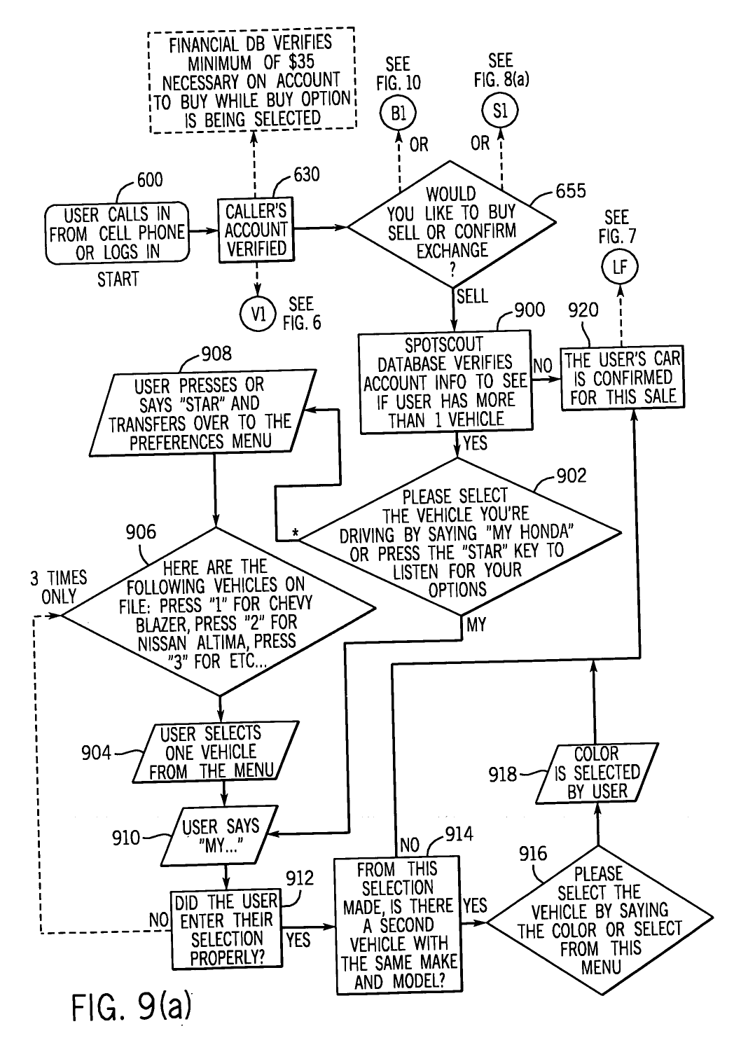

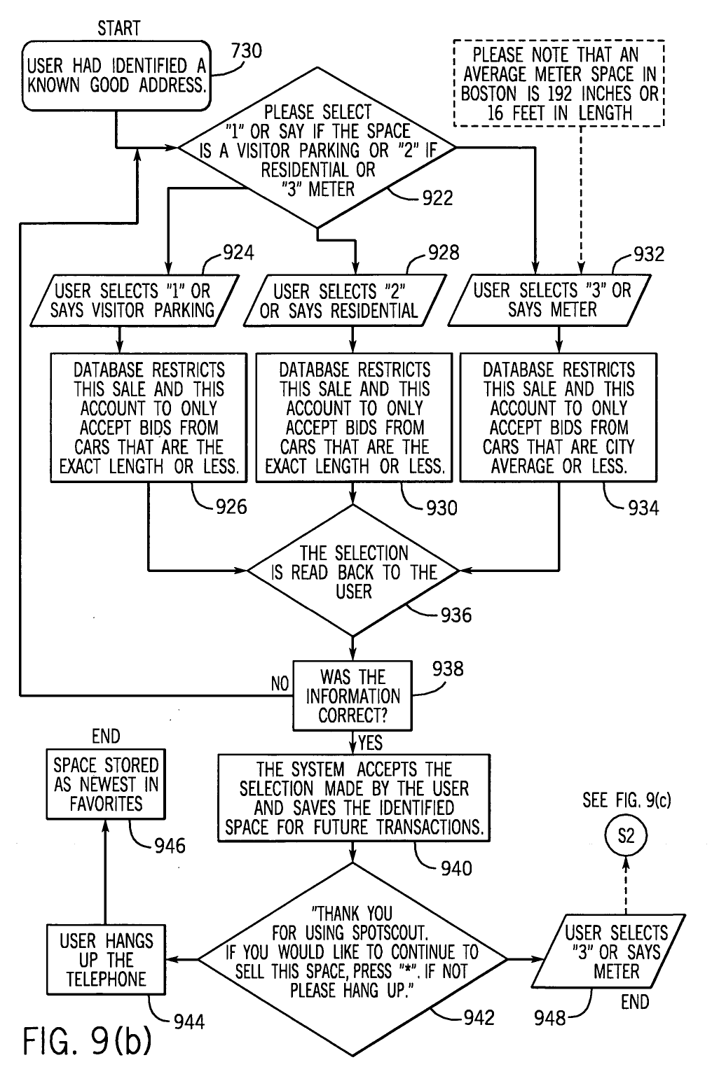

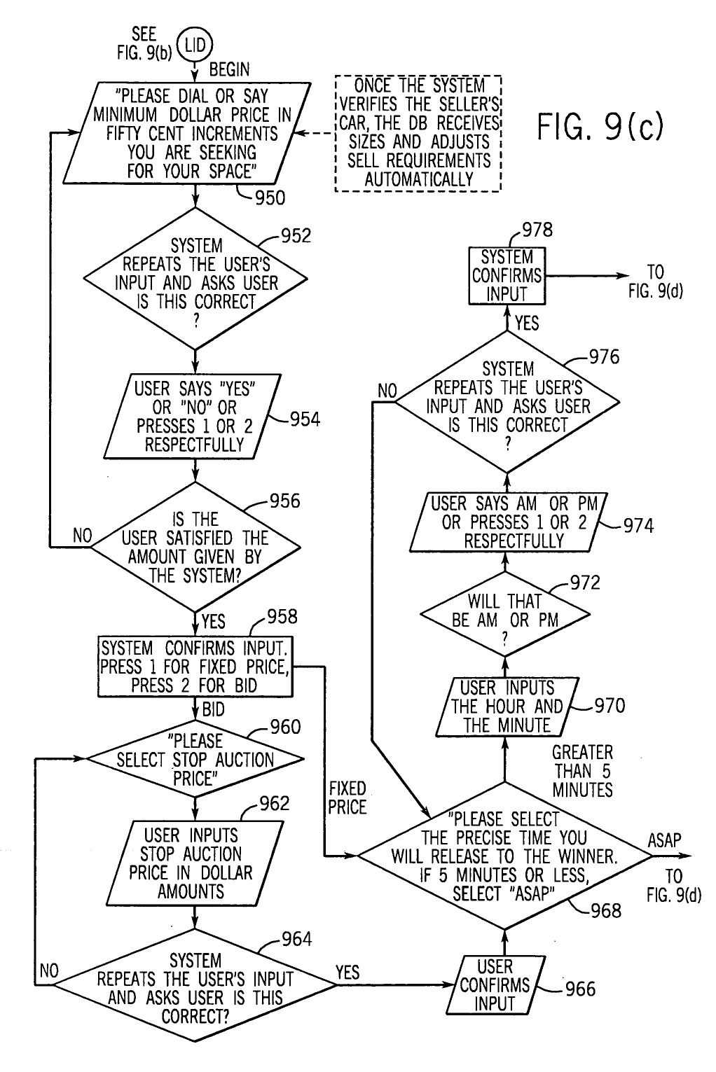

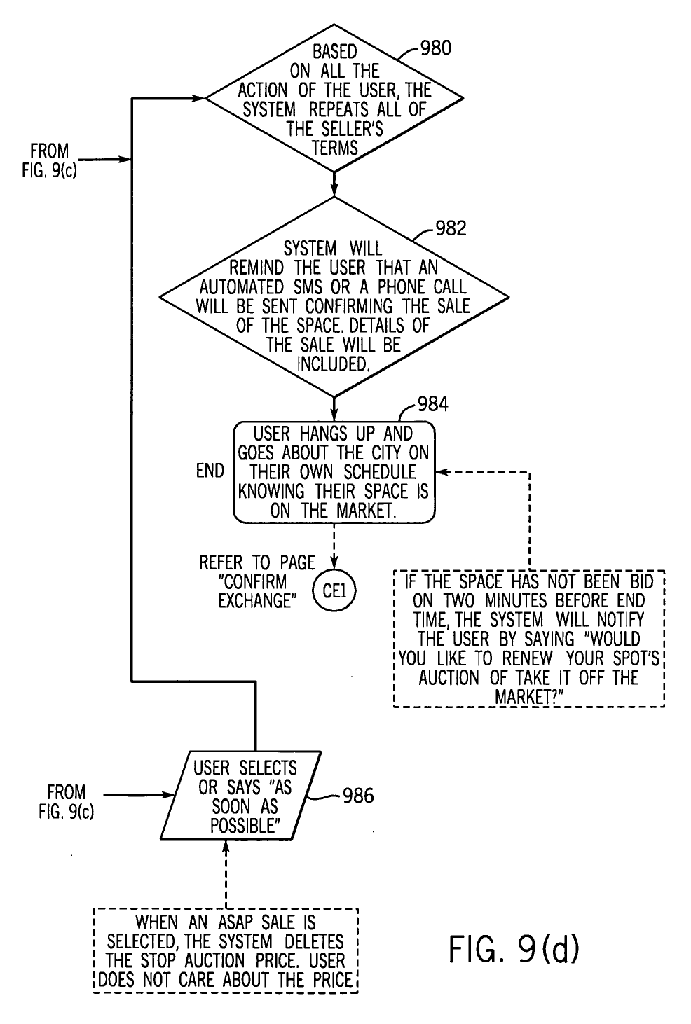

Referring to FIG. 9(a), a SpotCasting end user can choose to sell a parking space at step 655. The SpotCasting end user's pre-recorded vehicle information can be accessed to determine whether or not the SpotCasting end user has multiple vehicles in step 900. The Spotcasting end user can then select which one of his or her vehicles is currently occupying a parking space that the will be vacated in step 902. This ability to associate a Spotcasting end user with his or her vehicles is especially useful in parking garages where there are different size parking spaces or when an available parking space is a public space and the size of the parking space can again vary. The SpotCasting end user is presented with a list of his or her vehicles in step 906 and he or she selects one of those vehicle choices in step 904. Alternatively, if a VXML or IVR client is being utilized, a SpotCasting end user can simply identify his or her vehicle by name instead of choosing from a list as in step 910. At step 912, it is determined whether or not the SpotCasting end user has entered his or her vehicle selection correctly. It is also determined whether the SpotCasting end user has more than one vehicle of the same type in step 914. This is useful for helping a SpotScouting end user that buys the SpotCasting end user's to-be-available parking space locate the parking space as vehicle make, model, color, and location can be presented. If this is the case, the color of the vehicle is selected by the SpotCasting end user at step 915, after which the vehicle is confirmed for the current transaction at step 920.

Referring to FIG. 9(b), the SpotCasting end user is prompted to select the type of parking space he or she wishes to SpotCast at step 922. If the SpotCasting end user selects for example, “visitor parking,” at step 924, the space service is able to limit prospective SpotScouting end users to those that have a vehicle that can be accommodated by a “visitor parking” space at step 926. If the SpotCasting end user selects for example, “residential parking,” at step 928, the space service is able to limit prospective SpotScouting end users to those that have a vehicle that can be accommodated by a “residential parking” space at step 930. If the SpotCasting end user selects for example, “meter parking,” at step 932, the network 400 is able to limit prospective SpotScouting end users to those that have a vehicle that can be accommodated by a “meter parking” space at step 934. The SpotCasting end user's selection is presented back to him or her at step 936 and the information is verified at step 938. If the SpotCasting end user's selection is accepted, the parking space is identified and saved for future transactions if desired in step 940. The SpotCasting end user is then given the option to continue with the process of broadcasting the parking space to SpotScouting end users in step 942. If the SpotCasting end user chooses not to broadcast the parking space and disconnects from the space service as in step 944, the space is stored as a newest favorite in step 946. If the SpotCasting end user does choose to continue the broadcasting process, he or she indicates is by, for example, entering “star” as in step 948.

Referring to FIG. 9(c), the SpotCasting end user is able to enter an asking price for his or her parking space in step 950. The price is repeated back to the SpotCasting end user in step 952 and can be verified in step 954. If the SpotCasting end user is satisfied at this point, he or she can continue on from step 956 and allow confirmation of the price at step 958, or repeat the process and return to step 950. The SpotCasting end user has the option to ask for a set price. However, as discussed above, the SpotCasting end user also has the ability to allow SpotScouting end users to bid on his or her parking space. In this case, a SpotCasting end user can enter a minimum price he or she is willing to accept in return for his or her parking space, as well as an auction stop price in steps 960 and 962. Again, the price is verified in step 964 and the SpotCasting end user can confirm the price in step 966. The SpotCasting end user is then prompted to select a time of release, which includes a time that he or she will release the parking space to the winning SpotScouting end user at step 968. If the release time is greater than five minutes away from the present time, the user inputs the hour and minute at step 970 and whether it is AM or PM at step 972. The SpotCasting end user makes the appropriate selection at step 974 and the time is repeated back at step 976 for verification and confirmed at step 978. If the SpotCasting end user is unsatisfied with the time, they are returned to step 968 to repeat the process.

Alternatively, a SpotCasting end user can indicate that the parking space will be available immediately as in step 986, at which point, the stop auction price can be ignored as the SpotCasting end user merely wants to get what he or she can for the parking space. Based on the actions of the SpotCasting end user, the network application 330 repeats the information for verification at step 980. Furthermore, at step 982, the SpotCasting end user is reminded that an automated SMS message or other notification will be sent confirming the sale of the parking space if it occurs. The SpotCasting end user can then simply disconnect from the space service and go about his or her business as in step 984. If a SpotCasting offer is not accepted, the SpotCasting end user is given the chance to rebroadcast/edit the SpotCasting offer or extend the period of availability.

Alternatively, the SpotCasting end user can be presented with a “select date/time slot and details interface” where the SpotCasting end user can enter or choose additional time of release data, including a day(s) and a duration of time that a parking space will be unoccupied and available as seen in steps. This again is advantageous to the SpotScouting end user, as it gives him or her a specific time to be present at a to-be-available parking space. This is especially important in the case of public street parking, for example, where a parking space can be lost in a matter of seconds. Therefore, the SpoutScouting end user is able to arrive just before the SpotCasting end user is supposed to vacate the parking space. Furthermore, this information can be set to be repeatedly broadcast. This is useful when, for example, a SpotCasting end user occupies a parking space only during the days, but the parking space would be available to SpotScouting ends users during the evening.

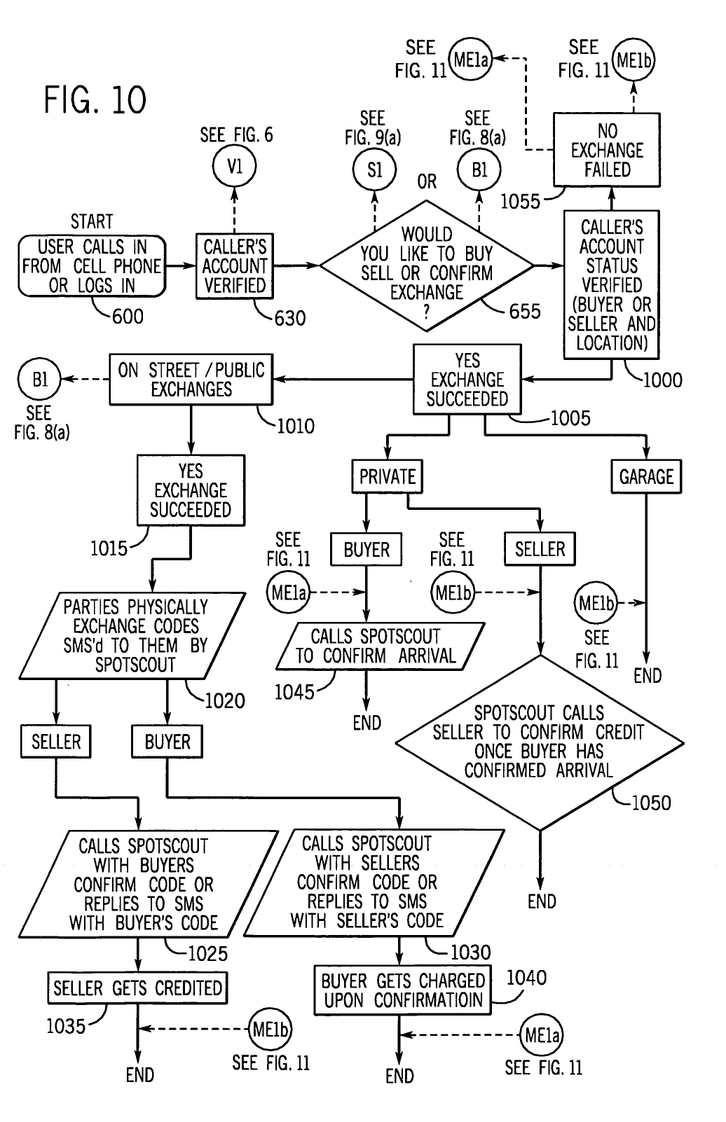

Referring to FIG. 10, both a SpotCasting end user and a SpotScouting end user can choose to confirm and exchange as in step 655. If the exchange is for public or street parking as in step 1010, and is successful as in step 1015, the SpotCasting end user and the SpotScouting end user physically exchange confirmation codes that each received as discussed above when they are both at the SpotCasted parking space. A “confirm arrival interface” will be presented to both the SpotScouting end user and the SpotCasting end user upon which both end users enter their respective, exchange confirmation codes presented to him or her earlier or sent by SMS at steps 1025 and 1030 respectively. Thereafter, the SpotCasting end user's account is credited the appropriate amount of money and the SpotScouting end user's account is debited in steps 1035 and 1040 respectively. If the exchange is for a private parking space, and a SpotCasting offer is accepted, once the SpotScouting end user arrives at the reserved parking space, he or she can return to the choose service interface described above and select to confirm his or her arrival as seen in step 1045. Concurrently, in one embodiment of the present invention, the network 400 notifies the SpotCasting end user to confirm a credit to his or her account once the SpotScouting end user has confirmed his or her arrival at the parking space as seen in step 1050.

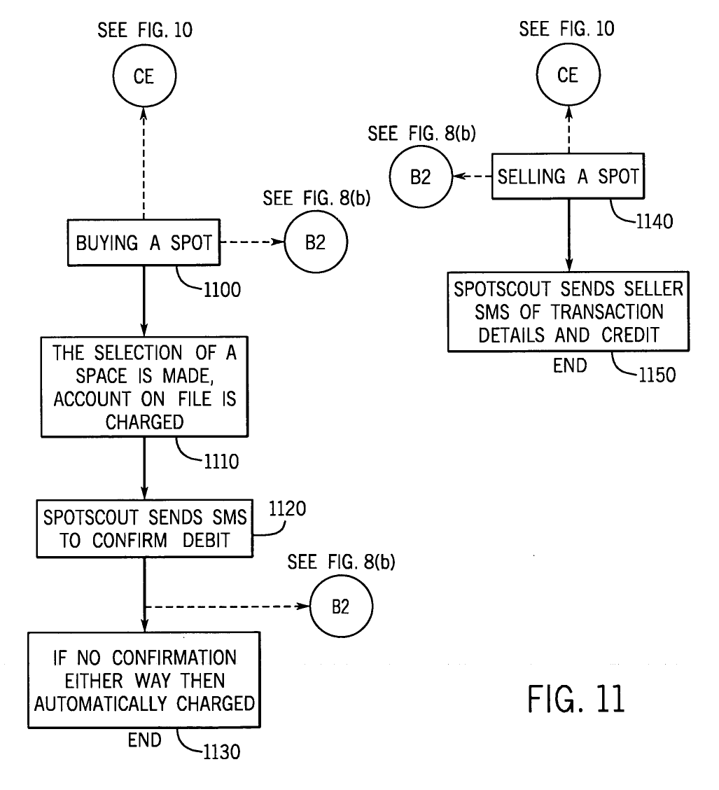

Referring to FIG. 11, once a SpotScouting end user has purchased a parking space in step 1110, and his or her account has been debited, a notification is sent to confirm the debit, preferably by an SMS message as in step 1120. For a SpotCasting end user, a notification is sent indicating the transaction details and the monetary credit to his or her account as already discussed above. If for some reason, no confirmation is received, the SpotScouting end user's account is still charged as seen in step 1130. If the exchange is for a garage parking space, the network 400 sends the garage owner, who is acting as a SpotCasting end user a notification of the transaction, the details and a credit to his or her account as seen in step 1150. Also, the SpotScouting end user who purchased the garage parking space can present his or her confirmation to a parking attendant or payment validator, electronic or otherwise, of the parking garage either upon entering the garage or exiting the garage.

Another aspect of the present invention is the ability to rate transactions. As mentioned above, a SpotScouting end user has the option to categorize available parking spaces by rating. This means that a SpotScouting end user can rate a SpotCasting end user or the physical parking space itself, if for example, the parking space is a garage or possibly also the area where a street parking space is located. Whether it is a SpotCasting end user or a SpotScouting end user, a rate selected transaction/parking event interface can be presented to the end user. The transaction/event can be identified by location or date/time and a rating of satisfied or dissatisfied can be entered for that transaction. Optionally, a more detailed feedback description can be entered as well. In the future it is contemplated that rating can be accomplished by a graded method as well, i.e., transactions can be given a 1-10 rating instead of simply a satisfied or dissatisfied rating. Rating skins that audibly or visually represent ratings, including depictions of well-known individuals, may also be used to personalize the appearance of the interface according the an end user's wishes or mood.

An end user of the present invention can also be an actual parking garage owner. A parking garage owner is likely to utilize the present invention as a SpotCasting end user to broadcast available parking spaces within the parking garage. Referring back to FIG. 10, the parking garage owner can simply create an account just like any other SpotCasting end user and utilize the space service as described above and have money credited to his or her account. This can be accomplished through a dedicated garage management console or a direct database tie-in to the network. Alternatively, certain extra features can be provided to parking garage owners. For example, a parking garage owner can be given the option to manage multiple garage properties under his or her control by adding and deleting properties, setting rates and schedules of operation, adding a logo or avatar to his or her SpotCasting offers that are be visible to SpotScouting end users. Moreover, even if parking garage owners currently have the known sensor-type advance parking systems technology in their garage(s), it can be integrated into the network 400 as a dedicated data source/server. This also overcomes the present limitations of current advanced parking system limitations by giving parking garage owners the opportunity to broadcast available parking to a much wider audience, over a much more dynamic network.

It is noted that all the information discussed above can be accessed and edited by either a SpotCasting or SpotScouting end user, system administrator, or customer service representative, apart from entering a SpotScouting or SpotCasting event. This is useful when a SpotCasting or SpotScouting end user wishes to look over his or her account summary for example.

It should be further noted that this system and method of optimizing the utilization of space can be applied to many contemplated areas such as seating in a restaurant or event venue, sharing space in a moving container, exchanging a place in a queue or line, or even virtual space such as logical memory. Of course, appropriate parameters and interfaces for these other space opportunities can easily be incorporated into the present invention. In fact, it is even contemplated by the inventor that the roles of a SpotCasting end user and a SpotScouting end user can be reversed so to speak. In that case, a SpotScouting end user can broadcast a request for an available space and an end user having control over a desired space, who traditionally would be defined as a SpotCasting end user, can respond to the SpotScouting end user's request.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention can be accomplished with standard programming techniques with rule based logic and other logic to accomplish the various database searching steps, correlation steps, comparison steps and decision steps. It should also be noted that the words “element” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method for optimizing utilization of available space comprising:
inputting at least one space parameter, at least one desired location parameter, and estimated time of use data by a first user;
retrieving and aggregating data regarding at least one available space broadcast by at least one second user that meet requirements specified by the at least one space parameter, the at least one desired location parameter, and the estimated time of use data;
organizing the at least one available space into further combinable categories for selection by a first user;
conducting at least one transaction wherein the first user is able to reserve the at least one available space for use at substantially the time of use; and
providing the first user with directions to the at least one available space reserved by the first user and a confirmation notification including at least a confirmation code associated with the at least one transaction.

2. The method of claim 1, wherein the inputting is performed by the first user utilizing an electronic device capable of operating over at least one of an extensible hypertext markup language (XHTML) client, a voice extensible markup language (VXML) client, a Java 2 Platform, Micro Edition (J2ME) client, a global positioning client, a FlashLite client, and a browser client.

3. The method of claim 1, wherein the at least one space parameter includes at least one spatial indicia identifying spatial characteristics of at least one entity that is to occupy the at least one available space.

4. The method of claim 1, wherein the at least one location parameter includes at least one location indicia identifying a desired location near the at least one available space.

5. The method of claim 4, further comprising gathering the at least one location indicia from a location selected from a group consisting of a point of interest (POI), a spot of interest (SOI), a landmark, and a geocoding address data source.

6. The method of claim 3, wherein the estimated time of use data includes at least one of a time the first user anticipates arriving near the at least one available space, and a duration of time the first user anticipates occupying the at least one available space with the at least one entity.

7. The method of claim 1, further comprising storing at least one of the inputted space parameter, location parameter, and estimated time of use data for future re-use.

8. The method of claim 1, wherein the conducting of a transaction further comprises:
submitting a set payment amount for the at least one available space from the first user;
permitting the first user to bid on a payment amount for at least one of the one or more available spaces; and
thereafter submitting a payment amount associated with a highest bid for at least one of the one or more available spaces.

9. The method of claim 3, further comprising occupying the at least one available space with the at least one entity.

10. The method of claim 9, further comprising:
re-broadcasting availability of the at least one available space after the at least one entity no longer occupies the at least one available space; and
allowing the first user and the second user to rate the conducted transaction based on a plurality of satisfaction parameters.

11. A method for optimizing utilization of available space comprising:
inputting at least one space parameter, at least one location parameter, and an estimated time of release data associated with a to-be-available space controlled at least in part by a first broadcasting user;
broadcasting to at least one scouting user, data regarding the to-be-available space including at least one of the least one space parameter, the at least one location parameter, and the estimated time of release data along with a plurality of data regarding other to-be-available spaces controlled by other broadcasting users, if such other to-be available spaces exist; and
conducting at least one transaction wherein the first broadcasting user receives a notification indicating that at least one scouting user has reserved the to-be-available space for use at least near the estimated time of release.

12. The method of claim 11, wherein the inputting is performed by the first broadcasting user utilizing an electronic device capable of operating over at least one of an extensible hypertext markup language (XHTML) client, a voice extensible markup language (VXML) client, a Java 2 Platform, Micro Edition (J2ME) client, a global positioning client, a FlashLite client, and a browser client.

13. The method of claim 11, wherein the at least one space parameter includes one or more spatial indicia identifying at least one of a spatial characteristic of the to-be-available space and a spatial characteristic of least one entity that currently occupies the to-be-available space.

14. The method of claim 11, wherein the at least one location parameter includes at least one location indicia identifying a location at least near the to-be-available space.

15. The method of claim 14, further comprising gathering the at least one location indicia from a location selected from a group consisting of a point of interest (POI), a spot of interest (SOI), a landmark, and a geocoding address data source.

16. The method of claim 13, wherein the estimated time of release data includes at least one of a time the first broadcasting user anticipates departing from the to-be-available space, and a duration of time the first broadcasting user anticipates not occupying the to-be-available space with the at least one entity.

17. The method of claim 11, further comprising storing at least one of the inputted space parameter, location parameter, and estimated time of release data for future re-use.

18. The method of claim 11, wherein the conducting of a transaction further comprises:
receiving a set payment amount for the to-be-available space from the at least one scouting user;
permitting the at least one scouting user to bid on a payment amount for the to-be-available space; and
thereafter receiving a payment amount associated with a highest bid for the to-be-available space.

19. The method of claim 13, further comprising removing the at least one entity from the to-be-available space.

20. The method of claim 19, further comprising:
re-broadcasting availability of the to-be-available space if no reservation has been received by the first broadcasting user at the time of release, including if the time of release has expired; and
allowing both the first broadcasting user and the at least one scouting user to rate the conducted transaction based on a plurality of satisfaction parameters.

21. A computer program product for optimizing utilization of available space comprising:
computer code for inputting at least one space parameter, at least one desired location parameter, and an estimated time of use data by a first user;
computer code for retrieving and aggregating data regarding at least one available space broadcast by at least one second user that meet requirements specified by the at least one space parameter, the at least one desired location parameter, and the estimated time of use data;
computer code for organizing the at least one available space into further combinable categories for selection by a first user;
computer code for conducting at least one transaction wherein the first user is able to reserve the at least one available space for use at substantially the time of use; and
computer code for providing the first user with directions to the at least one available space reserved by the first user and a confirmation notification including at least a confirmation code associated with the at least one transaction.

22. The computer program product of claim 21, wherein the at least one space parameter includes at least one spatial indicia identifying spatial characteristics of at least one entity that is to occupy the at least one available space.

23. The computer program product of claim 22, wherein the estimated time of use data includes at least one of a time the first user anticipates arriving near the at least one available space, and a duration of time the first user anticipates occupying the at least one available space with the at least one entity.

24. The computer program product of claim 21, wherein the conducting of a transaction further comprises:
submitting a set payment amount for the at least one available space from the first user;
permitting the first user to bid on a payment amount for at least one of the one or more available spaces; and
thereafter submitting a payment amount associated with a highest bid for at least one of the one or more available spaces.

25. The computer program product of claim 22, further comprising:
re-broadcasting availability of the at least one available space after the at least one entity no longer occupies the at least one available space; and
allowing the first user and the second user to rate the conducted transaction based on a plurality of satisfaction parameters.

26. A computer program product for optimizing utilization of available space comprising:
computer code for inputting at least one space parameter, at least one location parameter, and an estimated time of release data associated with a to-be-available space controlled at least in part by a first broadcasting user;
computer code for broadcasting to at least one scouting user, data regarding the to-be-available space including at least one of the least one space parameter, the at least one location parameter, and the estimated time of release data along with a plurality of data regarding other to-be-available spaces controlled by other broadcasting users, if such other to-be available spaces exist; and
computer code for conducting at least one transaction wherein the first broadcasting user receives a notification indicating that at least one scouting user has reserved the to-be-available space for use at least near the estimated time of release.

27. The computer program product of claim 26, wherein the at least one space parameter includes one or more spatial indicia identifying at least one of a spatial characteristic of the to-be-available space and a spatial characteristic of least one entity that currently occupies the to-be-available space.

28. The computer program product of claim 27, wherein the estimated time of release data includes at least one of a time the first broadcasting user anticipates departing from the to-be-available space, and a duration of time the first broadcasting user anticipates not occupying the to-be-available space with the at least one entity.

29. The computer program product of claim 26, wherein the conducting of a transaction further comprises:
receiving a set payment amount for the to-be-available space from the at least one scouting user;
permitting the at least one scouting user to bid on a payment amount for the to-be-available space; and
thereafter receiving a payment amount associated with a highest bid for the to-be-available space.

30. The computer program product of claim 26, further comprising:
re-broadcasting availability of the to-be-available space if no reservation has been received by the first broadcasting user at the time of release, including if the time of release has expired; and
allowing both of the first broadcasting user and the at least one scouting user to rate the conducted transaction based on a plurality of satisfaction parameters.

31. An electronic device comprising:
a processor; and
a memory unit operatively connected to the processor and including:
computer code for inputting at least one space parameter, at least one desired location parameter, and an estimated time of use data by a first user;
computer code for retrieving aggregated data regarding at least one available space broadcast by at least one second user that meet requirements specified by the at least one space parameter, the at least one desired location parameter, and the estimated time of use data;
computer code for organizing the at least one available space into 11 further combinable categories for selection by a first user;
computer code for conducting at least one transaction wherein the first user is able to reserve the at least one available space for use at least near the time of use; and
computer code for providing the first user with directions to the at least one available space reserved by the first user and a confirmation notification including at least a confirmation code associated with the at least one transaction.

32. The electronic device of claim 31, wherein the at least one space parameter includes at least one spatial indicia identifying spatial characteristics of at least one entity that is to occupy the at least one available space.

33. The electronic device of claim 32, wherein the estimated time of use data includes at least one of a time the first user anticipates arriving near the at least one available space, and a duration of time the first user anticipates occupying the at least one available space with the at least one entity.

34. The electronic device of claim 31, wherein the conducting of a transaction further comprises:
submitting a set payment amount for the at least one available space from the first user;
permitting the first user to bid on a payment amount for at least one of the one or more available spaces; and
thereafter submitting a payment amount associated with a highest bid for at least one of the one or more available spaces.

35. The electronic device of claim 32, further comprising:
re-broadcasting availability of the at least one available space after the at least one entity no longer occupies the at least one available space; and
allowing the first user and the second user to rate the conducted transaction based on a plurality of satisfaction parameters.

36. An electronic device comprising:
a processor; and
a memory unit operatively connected to the processor and including:
computer code for inputting at least one space parameter, at least one location parameter, and an estimated time of release data associated with a to-be-available space controlled at least in part by a first broadcasting user;
computer code for broadcasting to at least one scouting user, data regarding the to-be-available space including at least one of the least one space parameter, the at least one location parameter, and the estimated time of release data along with a plurality of data regarding other to-be-available spaces controlled by other broadcasting users, if such other to-be available spaces exist; and
computer code for conducting at least one transaction wherein the first broadcasting user receives a notification indicating that at least one scouting user has reserved the to-be-available space for use at least near the estimated time of release.

37. The electronic device of claim 36, wherein the at least one space parameter includes one or more spatial indicia identifying at least one of a spatial characteristic of the to-be-available space and a spatial characteristic of least one entity that currently occupies the to-be-available space.

38. The electronic device of claim 37, wherein the estimated time of release data includes at least one of a time the first broadcasting user anticipates departing from the to-be-available space, and a duration of time the first broadcasting user anticipates not occupying the to-be-available space with the at least one entity.

39. The electronic device of claim 36, wherein the conducting of a transaction further comprises:
receiving a set payment amount for the to-be-available space from the at least one scouting user;
permitting the at least one scouting user to bid on a payment amount for the to-be-available space; and
thereafter receiving a payment amount associated with a highest bid for the to-be-available space.

40. The electronic device of claim 36, further comprising:
re-broadcasting availability of the to-be-available space if no reservation has been received by the first broadcasting user at the time of release including if the time of release has expired; and
allowing both of the first broadcasting user and the at least one scouting user to rate the conducted transaction based on a plurality of satisfaction parameters.

41. A network application for use in a network that optimizes the utilization of space comprising:
a buyer module for storing and retrieving first information related to a first user looking for at least one available space within a given timeframe;
a seller module for storing and retrieving second information related to a second user interested in broadcasting the second information to the network regarding availability of at least one to-be-available space at, at least one of a specific time, time interval, and series of intervals;
a space module for storing and retrieving third information relating to the at least one to-be-available space that is broadcast to and available through the network at, at least one of a specific time, time interval, and series of intervals, and a position of that to-be-available space;
a schedule module for storing and retrieving fourth information relating to at least one of the specific time and time interval, that a previously occupied space becomes a to-be-available space; and
a transaction module for storing and retrieving fifth information relating to transactions that occur due to exchanging of the first, second, third, and fourth information within the network.

42. A network architecture for optimizing the utilization of space comprising:
a plurality of data sources for storing and transmitting first information related to a first set of users looking for available spaces within a given timeframe, and second information related to a second set of users interested in broadcasting the second information to the network regarding availability of to-be-available spaces at, at least one of a specific time, time interval, and series of intervals;
a network application including:
a data layer, wherein the plurality of data sources reside;
a domain layer having a standardized set of getters and setters for interacting with the plurality of data sources to create, retrieve, update, and delete the first and the second information from the plurality of data sources, and for aggregating the first and the second information from the plurality of data sources;
a service layer for receiving responses from the first set and the second set of users, requesting the domain layer to set and get the first and the second information from the plurality of data sources, and effecting transactions and communication between modules of the domain layer; and
a user interface layer for interfacing with a network application and the first set and the second set of users for providing the second information to the first set of users, and for retrieving the first information from the first set of users.
